(19) United States
(12) Patent Application Publication
(10) Pub. No.: US 2010/0156141 A1
(43) Pub. Date: Jun. 24, 2010

(54) VEHICLE FLAP ARRANGEMENT

(75) Inventor: Tobias Mueller, Muenchen (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: WEBASTO AG, Stockdorf (DE)

(21) Appl. No.: 11/720,697

(22) PCT Filed: Nov. 23, 2005
(86) PCT No.: PCT/DE2005/002127

§ 371 Date: Sep. 25, 2009

(30) Foreign Application Priority Data
Dec. 1, 2004 (DE) 10 2004 058 114.2

(51) Int. Cl. B60J 5/10

(52) U.S. Cl. 296/146.8

(57) ABSTRACT

The invention concerns a shutter system designed for a shutter (4) mounted on a vehicle body so as to be mobile relative thereto. The invention is characterized in that the shutter is maintained at least at one of its two lateral ends by a quadruple hinge mechanism formed by two main hinge elements (10, 12) which are mounted pivotable on the body (8), and a linking hinge element (16) which links together the free ends of the main hinge elements; and an adjusting motor (22) is mounted on the shutter itself, to move at least one of the quadruple hinge mechanisms. According to the invention, at least one main hinge element (10) of one quadruple hinge mechanism, is secured to the shutter or is a component of the shutter, and the linking hinge element (16) is pivotable relative to the adjusting motor means (22).

### BACKGROUND OF THE INVENTION

1. Field of Invention

This invention relates to a vehicle flap arrangement for a flap which is movably arranged on a vehicle body, the flap being held via a four-bar arrangement on at least one of its two side ends, the four-bar arrangement being are formed from two main rods which are pivotally supported on the body and a linking rod which connects the free ends of the main rods to one another, on the flap itself there being a positioning motor for positioning at least one bar of the four-bar arrangement.

2. Description of Related Art

These flaps which can be moved by positioning motors are, for example, tailgates, trunk lids, covers of convertible top compartments, spoilers and the like. Generally, the positioning motors for positioning these flaps and the gearing elements, etc., which are drive-connected to them, are located on the body, especially when the axis of rotation of the flap lies outside the flap itself. The positioning drive generally takes up valuable structural space within the body which then can no longer be used as stowage space. On the other hand, the structural pace in the flap is not used.

European Patent Application EP 1 134 104 A1 discloses a rear tailgate arrangement, in which a lower flap segment is movably located on an upper flap segment. The lower flap segment is movably supported via four-bar arrangements provided on its two side ends. The driving of the lower flap segment for positioning takes place via a positioning motor located on this flap segment itself and which positions the two four-bar arrangements, and thus, the lower flap segment relative to the upper flap segment via suitable transmission means. In the known construction, the linking rod is located mounted on the flap or is formed by a section of the flap itself. In this way, the flap, when positioned, executes essentially translational motion without pivoting, especially when the four-bar arrangements are symmetrical quadruple articulations with main rods of the same length. Pivoting, which is repeatedly required for flap arrangements of motor vehicles for opening, is not possible with this construction.

### SUMMARY OF THE INVENTION

The object of this invention is to devise a flap arrangement for a flap which is adjustably arranged on a vehicle body, the flap being held on at least one of its two side ends via a four-bar arrangement which is formed from two main rods which are pivotally supported on the body and at least one linking rod which connects the free ends of the main rods to one another, and a positioning motor for positioning at least one four-bar arrangement being located on the flap itself, with which pivoting of the flap is possible, especially around a pivot axis which lies outside the actual flap.

This object is achieved in accordance with the invention by at least one main rod of the four-bar arrangement being mounted on the flap, and the at least one linking rod being arranged to pivot relative to the flap.

The invention exploits the finding that, when a four-bar arrangement of the initially described type is positioned, the two main rods of the four-bar arrangement execute pure pivoting motion in contrast to the linking rod. Accordingly, if at least one main rod of the laterally located four-bar arrangements is mounted on the flap, the flap also executes a pivoting motion around the coupling point of this main rod on the body. The linking rod or rods can then each be pivoted relative to the flap. i.e., they have the function of a crank which is driven in rotation by a positioning motor, the crank rotation leading to positioning of the four-bar arrangement, as is explained below.

According to another configuration of the invention, the positioning motor is arranged on the flap and designed such that it can pivot the linking rod of at least one four-bar arrangement relative to the assigned flap-mounted main rod. A certain pivoting position of the main rod relative to the body corresponds to each setting angle of the linking rod relative to the assigned main rod. By pivoting the linking rod relative to the assigned main rod, accordingly, the pivoting motion of this main rod, and thus, the flap integrated with it, can be pivoted relative to the body. According to one preferred mechanical configuration of the invention, it is provided that the flap-mounted main rods project roughly transversely relative to the main plane of the flap. Accordingly, these main rods are not in the main plane of the flap, but are at essentially at any angle transversely to this main plane so that, for example, when the main rods are pivoting essentially around the horizontal center position, the flap itself can stand essentially vertically, as is described below.

The flap-mounted main rods can also be components of the flap according to another configuration of the invention, i.e., can be formed by a section of the flap itself

According to one preferred configuration of the invention, the positioning motor is an electric motor which, in spite of its concomitant movement with the flap, can be electrically connected to the electrical system of the vehicle without technical difficulties via contact-making provided in the hinge region. The positioning motor is, for example, a geared motor with a rotating output shaft which is drive-connected to the linking rod so that it can pivot the latter relative to the flap-mounted main rod. Of course, it is also possible to connect the positioning motor to the two linking rods via suitable transmission means, such as shafts, rods, and/or geared or belt drives.

One embodiment of the invention is shown in the drawings and is explained in detail below.

### BRIEF DESCRIPTION OF THE DRAWINGS

FIG. 1 schematically shows the rear part of a vehicle with a trunk lid in the closed and in the opened position;

FIG. 2 schematically shows the suspension of the rear part;

FIG. 3 schematically shows a four-bar arrangement for supporting a rear flap or the like in the opened or closed position.

### DETAILED DESCRIPTION OF THE INVENTION

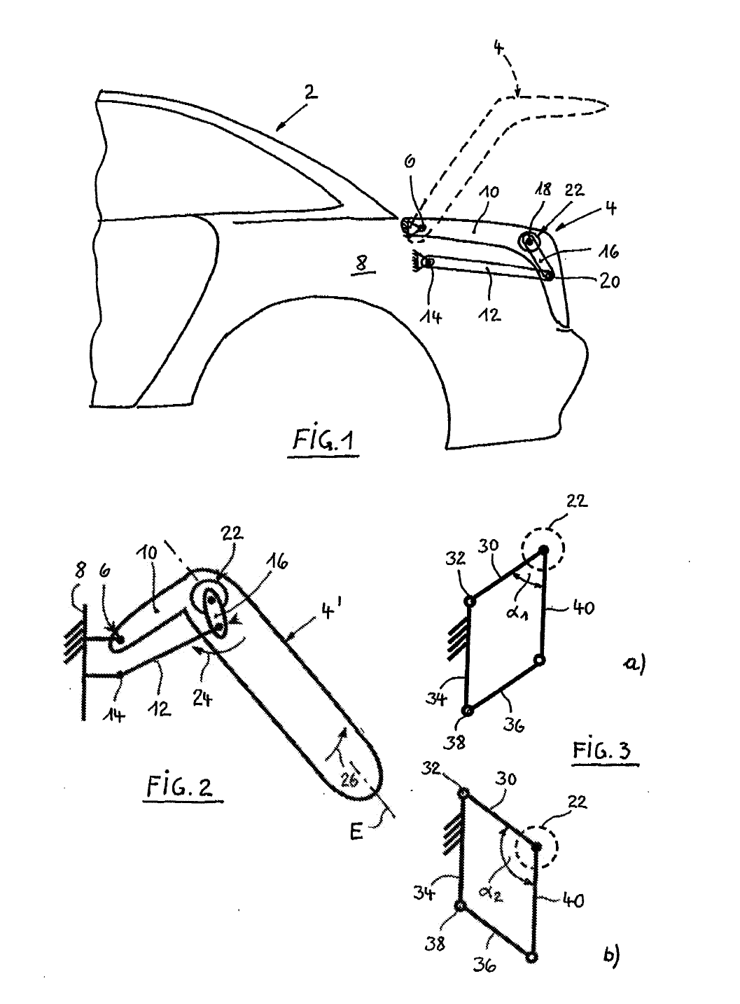

On the rear of the vehicle 2 which is shown in FIG. 1, in the conventional manner, a trunk lid 4, which covers the trunk, is pivotally arranged between a closed position shown by the solid line and an open position shown by the broken line. The pivot axis 6 of the trunk lid 4 is crosswise to the vertical center plane of the vehicle 2.

On each of the two side ends of the trunk lid there is a respective four-bar arrangement on which the trunk lid 4 is supported and actuated, and of which only one four-bar arrangement is shown in FIG. 1. This four-bar arrangement comprises two main rods 10, 12 which are pivotally supported on the body 8 of the vehicle 2 and a linking rod 16 which connects the free ends of the main rods to one another; the operation of the linking rod is explained below.

The first main rod 10 is formed by the section of the trunk lid 4 which lies roughly horizontally in the closed state of the trunk lid 4. A second main rod 12 of roughly the same length, which is located roughly parallel to the first main rod 10, is supported on the body 8 to be pivotable around the pivot axis 14. The main rods 10, 12 are connected to one another on their ends away from the body by a linking rod 16 which, on the one hand, is supported to pivot around a pivot axis 18 on the trunk lid 4, and on the other, is connected via a swivel joint 20 to the second main rod 12.

The linking rod 16 is drive-connected to the positioning motor 22 which is located on the trunk lid 4, by means of which the linking rod 16 can be pivoted relative to the trunk lid 4, i.e., opposite the first main rod 10. By pivoting of the linking rod 16, the four-bar arrangement, and thus, also the trunk lid 4 which is coupled to it are positioned, as is explained especially with reference to FIG. 3 below.

FIG. 2 schematically shows an arrangement roughly according to FIG. 1 for pivoted support of the rear flap 4′, the elements corresponding to the elements of FIG. 1 being provided with the same reference numbers. The positioning motor 22 positions the linking rod 16 which, accordingly, has the function of a rotary crank. This second main rod 12, which is connected to this crank, on the one hand, and to the pivot axis 14, on the other has the function of a connecting rod. By pivoting the crank (linking rod 16) in the direction of the arrow 24, the first main rod 10, and thus, the rear flap 4′, are pivoted in the direction of the arrow 26, i.e., therefore, in the opening direction. As indicated in FIG. 2, the first main rod 10 is not in the main plane of the rear flap 4′, but roughly crosswise to it.

FIG. 3 schematically shows the four-bar arrangement roughly according to FIGS. 1 & 2, FIG. 3a showing the four-bar arrangement corresponding to the position in which the flap is in the open position and FIG. 3b showing the four-bar arrangement in the position corresponding to the closed position of the assigned flap. In FIGS. 3a , 3b the first main rod is labeled 30; it is mounted on the flap or forms a component of the flap, as is shown, for example, in FIG. 1. The first main rod is arranged on the body 34 to be able to pivot around the pivot axis 32. A second main rod 36 is supported on the body 34 likewise to be able to pivot around the pivot axis 38. The two body-mounted free ends of the first main rod 30 and of the second main rod 36 are connected to one another via a linking rod 40.

A positioning motor 22 is supported relative to the first main rod 30, i.e., opposite the flap, and is drive-connected to the linking rod such that it can pivot the latter relative to the first main rod 30. Each angle α between the first main rod 30 and the linking rod 40 corresponds to a certain pivoting position of the first main rod 30 relative to the body 34, i.e., a certain opening angle of the flap. In order, for example, to transfer the four-bar arrangement out of the open position shown in FIG. 3a into the closed position shown in FIG. 3b, the linking rod 40 is pivoted relative to the first main rod 30 in the sense of increasing the angle alpha (α1 → α2), and thus, the flap assigned to the four-bar arrangement is closed. To open the flap, the linking rod 40 is pivoted in the sense of reducing the angle alpha (α2 → α1).

The arrangement of the quadruple articulation 10, 16, 12 can be located on both sides of the flap 4, either, on each side, there being a positioning motor 22—preferably with corresponding synchronization of the two drives→or the positioning motor 22 being located on only one side and its drive forces or moments are transmitted to the two quadruple articulations or from one quadruple articulation to the other. The transmission means can be rotary shafts, cables, cords, geared or belt drives→also in combination with one another. In the simplest case, there is a quadruple articulation 10, 16, 12 with a positioning motor 22 on only one side of the flap 4, the flap 4 then being actively driven asymmetrically only on one side, while on the other side only simple support on one body-mounted pivot axis 6 being provided.

1-9. (canceled)

10. Flap arrangement for a flap which is adjustably arranged on a vehicle body, the flap being held on at least one of its two side ends via at least one four-bar arrangement which is formed from two main rods which are pivotally supported on the body and at least one linking rod which connects the free ends of the main rods to one another, and a positioning motor for positioning the at least one four-bar arrangement and that is located on the flap itself, wherein one of the main rods is mounted on the flap, and the at least one linking rod is arranged to pivot relative to the flap.

11. Flap arrangement as claimed in claim 10, wherein the positioning motor is arranged for pivoting the linking rod relative to the main rod of the at least one four-bar arrangement that is mounted on the flap.

12. Flap arrangement as claimed in claim 10, wherein the main rod that is mounted on the flap projects roughly transversely to a main plane of the flap.

13. Flap arrangement as claimed in claim 10, wherein the main rod that is mounted on the flap is formed by the flap itself.

14. Flap arrangement as claimed in claim 10, wherein the positioning motor is an electric motor.

15. Flap arrangement as claimed in claim 14, wherein the positioning motor is a geared motor with a rotating output shaft which is drive-connected directly to at least one linking rod.

16. Flap arrangement as claimed in claim 1, wherein the flap is one of a trunk lid, a rear tailgate and a convertible roof top.

17. Flap arrangement as claimed in claim 1, wherein the at least one a four-bar arrangement comprises a four-bar arrangement on each of opposite sides of the flap.

18. Flap arrangement as claimed in claim 17, wherein each of the four-bar arrangements is actuatable by a respective positioning motor.

19. Flap arrangement as claimed in claim 10, wherein the positioning motor is arranged for pivoting the linking rod relative to the main rod of the at least one four-bar arrangement that is mounted on the flap.

20. Flap arrangement as claimed in claim 19, wherein the main rod that is mounted on the flap projects roughly transversely to a main plane of the flap.

21. Flap arrangement as claimed in claim 19, wherein the main rod that is mounted on the flap is formed by the flap itself

22. Flap arrangement as claimed in claim 19, wherein the positioning motor is an electric motor.

23. Flap arrangement as claimed in claim 22, wherein the positioning motor is a geared motor with a rotating output shaft which is drive-connected directly to at least one linking rod.

24. Flap arrangement as claimed in claim 19, wherein the flap is one of a trunk lid, a rear tailgate and a convertible roof top.
